(19) United States
(12) Patent Application Publication
(10) Pub. No.: US 2013/0076058 A1
(43) Pub. Date: Mar. 28, 2013

(54) SUN VISOR FOR SHIELDING SUNLIGHT

(71) Applicant: Hong sub SHIN, Gwangju (KR)

(72) Inventor: Hong sub SHIN, Gwangju (KR)

(73) Assignee: HUMMER CO., LTD., Gwangju (KR)

(21) Appl. No.: 13/628,175

(22) Filed: Sep. 27, 2012

(30) Foreign Application Priority Data
Sep. 28, 2011 (KR) 10-2011-0098508

(51) Int. Cl. B60J 3/02

(52) U.S. Cl. 296/97.4; 296/97.6; 296/97.7

(57) ABSTRACT

Disclosed herein is a sun visor for shielding sunlight. The sun visor includes a housing. A coupler is inserted at one end into the housing to be taken into or out of the housing, with a fitting member provided on the other end of the coupler. A mover is coupled to one end of the coupler in such a way as to be provided in the housing, with a stopping means provided on one or both sides of the mover. A shielding panel movably is coupled to the fitting member of the coupler to adjust an angle thereof, and shields a driver's eyes from sunlight. A mover guide is provided in the housing, and includes an interference face to control movement of the mover by interference with the stopping means, and a mover guideway to guide the movement of the mover in a space defined by the interference face.

### BACKGROUND OF THE INVENTION

1. Field of the Invention

The present invention relates, in general, to a sun visor for shielding sunlight and, more particularly, to a sun visor provided in a vehicle or on a sun-visor plate to shield sunlight without obstructing a driver's field of view.

2. Description of the Related Art

Generally, in order to secure the field of view required for driving and also to ventilate a vehicle, the front, rear, and each door of the vehicle is equipped with window glass.

However, such window glass is formed to be transparent, so that sunlight passes through the window glass and is incident into a vehicle compartment. In the summer when the sunlight is strong, a driver's field of view is obstructed by the incident sunlight and the interior temperature of the vehicle rises.

In order to solve the problems, a sun visor for a vehicle is provided on a roof liner in the vehicle for each of a driver and a passenger sitting in a passenger seat. Such a conventional sun visor for the vehicle is mounted to an upper area in front of a driver's seat, so that the sun visor is unfolded down as necessary to shield sunlight during driving, and is folded up to be stored after use.

However, since such a conventional sun visor for the vehicle is simply attached to a vehicle body and coupled thereto in such a way as to perform only up-and-down rotation, only the up-and-down motion of the sun visor is ensured as described above. Such kind of sun visor for the vehicle is very small in an area for shielding sunlight, so that the sun visor is not very effective, and further it is impossible to effectively shield the sunlight having various incident angles that change with time.

In order to overcome these drawbacks, a conventional sun visor for a vehicle used a long and wide shielding panel that can cover most of the width of the driver's seat. However, such a sun visor is problematic in that it obstructs a driver's field of view while driving the vehicle, so that the sun visor may cause a traffic accident.

Therefore, there is needed technology that can effectively shield sunlight incident into the sun visor mounted to the vehicle without obstructing a driver's field of view.

To this end, Korean Patent No. 0974415 concerning a sun visor capable of shielding sunlight without obstructing a driver's field of view has been proposed, which was filed by the same applicant as this invention, was registered on Jul. 30, 2010, and is entitled Sun Visor for Shielding Sunlight.

According to the above technology, a shielding panel is simply mounted to a sun-visor plate of a vehicle to shield sunlight, and part of a bellows-type coupler is taken into a body by rotating a rotary handle and thus the length of the coupler varies.

However, the above technology is problematic in that the length of the coupler is adjusted by rotating the rotary handle, so that it is complicated to adjust the length of the coupler, and it is inconvenient for a user with thick fingers to rotate the rotary handle. Further, although the coupler is taken into the body when the shielding panel is not in use, the shielding panel is exposed to the outside, so that the appearance is not good and is in disorder.

### SUMMARY OF THE INVENTION

Accordingly, the present invention has been made keeping in mind the above problems occurring in the related art, and an object of the present invention is to provide a sun visor for shielding sunlight, which allows the length of a coupler to be easily adjusted, allows the coupler to be easily taken into a housing, and allows a shielding panel to be in close contact with a surface of a body so as to occupy a minimum area when the shielding panel is not in use, and which can adjust a position of a catcher when the shielding panel is mounted to a sun-visor plate, thus allowing the sun visor to be properly mounted to the sun-visor plate with a different area depending on a kind of a vehicle.

In order to accomplish the above object, the present invention provides a sun visor for shielding sunlight, including a housing; a coupler inserted at a first end thereof into the housing to be taken into or out of the housing, with a fitting member provided on a second end of the coupler; a mover coupled to the first end of the coupler in such a way as to be provided in the housing, with stopping means provided on one side or both sides of the mover; a shielding panel movably coupled to the fitting member of the coupler to adjust an angle thereof, and shielding a driver's eyes from sunlight; and a mover guide provided in the housing, and including an interference face to control movement of the mover by interference with the stopping means, and a mover guideway to guide the movement of the mover in a space defined by the interference face.

The housing may be mounted to an upper surface in the vehicle or detachably mounted to or the sun-visor plate of the vehicle. When the housing is detachably mounted to the sun-visor plate of the vehicle, a clamp may be provided on a first side of the housing to allow the housing to be detachably coupled to a first side of the sun-visor plate of the vehicle.

A catcher may be provided on a second side of the housing in such a way as to face the clamp and may be caught by a second side of the sun-visor plate, the catcher being provided such that a position thereof is moved by position moving means.

Here, the position moving means may include a pair of coupling bars coupled to a first side of the catcher in such a way as to be parallel to each other and inserted into the housing, a locking protrusion formed on an end of an outer surface of each of the coupling bars, a press portion formed on each of the coupling bars to cause the locking protrusion to engage with or disengage from an uneven portion, and the uneven portion provided in the housing and engaging with the locking protrusion to control movement of the catcher.

The coupler may be formed flexible to be bent freely and maintain a bent state, and may also be provided in the form of a telescopic antenna. Here, a circular protruding portion may be provided on the first end of the coupler to be surrounded by the mover and thus be freely movable from the mover without being removed therefrom, the mover including cut grooves that are formed along two surfaces of the mover to increase a rotating angular range of the coupler as the protruding portion moves.

A circular fitting protrusion may be provided on the fitting member, and a connector portion may be provided on a first side of the shielding panel to allow the shielding panel to move freely, with a coupler connecting connector being inserted into the connector portion, the fitting protrusion being fitted and coupled to the coupler connecting connector.

Here, a mirror may be attached to a surface of the shielding panel. When the coupler is taken into the housing, a surface of the shielding panel may be in contact with a surface of the housing so that the shielding panel overlaps with the housing, and a shielding-panel fastening hook may be provided on the surface of the housing to fasten the shielding panel thereto and thereby maintain an overlapping state.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is an exploded perspective view illustrating a sun visor for shielding sunlight according to an embodiment of the present invention;

FIG. 2 is a perspective view illustrating the sun visor for shielding sunlight according to the embodiment of the present invention;

FIG. 3 is a bottom perspective view of FIG. 1;

FIG. 4 is a view illustrating the use of the sun visor for shielding sunlight according to the embodiment of the present invention;

FIG. 5 is a sectional view illustrating the sun visor for shielding sunlight mounted to a sun-visor plate according to the embodiment of the present invention;

FIG. 6 is a view illustrating a state where a mover is inserted into a mover guide, in the sun visor for shielding sunlight according to the embodiment of the present invention;

FIG. 7 is a view illustrating a state where a coupler and the mover are coupled to each other, in the sun visor for shielding sunlight according to the embodiment of the present invention;

FIG. 8 is a view illustrating the process of taking a shielding panel out of a housing of the sun visor for shielding sunlight according to the embodiment of the present invention;

FIG. 9 is a view illustrating another coupler in the sun visor for shielding sunlight according to the embodiment of the present invention;

FIG. 10 is a view illustrating the state where a sun visor for shielding sunlight according to another embodiment of the present invention is installed in a sun-visor plate of a vehicle;

FIG. 11 is a sectional view of FIG. 10; and

FIG. 12 is a view illustrating the state where a sun visor for shielding sunlight according to a further embodiment of the present invention is mounted to an upper surface of the interior of a vehicle.

### DESCRIPTION OF PREFERRED EMBODIMENTS

Hereinafter, a sun visor for shielding sunlight according to the preferred embodiment of the present invention will be described in detail with reference to the accompanying drawings.

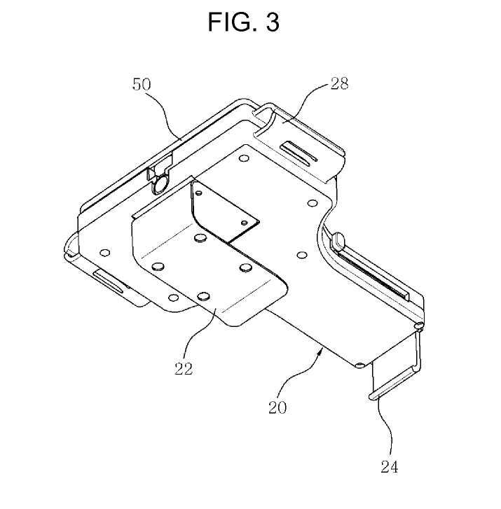

As shown in FIG. 3, the sun visor for shielding sunlight according to an embodiment of the present invention includes a housing 20. A coupler 30 is inserted at one end thereof into the housing 20 in such a way as to be taken in and out of the housing 20. A mover 40 is coupled to the end of the coupler 30 in such a way as to be provided in the housing 20. A shielding panel 50 is mounted to the other end of the coupler 30 to shield a driver's eyes from sunlight. A mover guide 60 is provided in the housing 20 to move the mover 40.

The housing 20 is provided with a first housing 21a and a second housing 21b that are separably assembled with each other using a rivet or the like. The mover guide 60 is formed in either of the first housing 21a or the second housing 21b, so that the first and second housings 21a and 21b can be assembled with the mover 40 inserted therebetween.

Further, a ticket fitting portion 27 is formed on the housing 20 to allow a toll ticket for driving on an expressway or a toll road or other tickets to be fitted and stored therein. Moreover, a writing-instrument inserting portion 28 is formed on any portion of the housing 20 to allow a writing instrument such as a ballpoint pen or a pencil to be inserted and stored therein. An elastic pin 28a having an elastic force is preferably provided on an inner circumference of the writing-instrument inserting portion 28 so as to prevent undesired removal of the writing instrument.

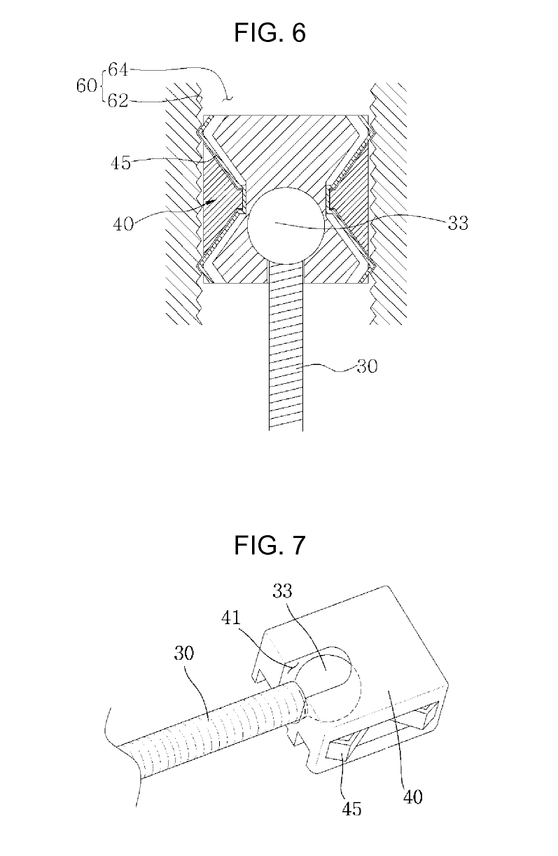

The mover 40 is configured to move along a mover guideway 64 of the mover guide 60 that is formed in the housing 20. As shown in FIG. 6, a stopping means 45 is provided on one side or both sides of the mover 40 to restrict the movement of the mover 40. The stopping means 45 restricts the movement of the mover 40 due to the interference between the stopping means 45 and interference faces 62 of the mover guide 60.

The interference faces 62 have an uneven shape, and are formed on opposite sides of the mover guideway 64. Of course, the interference face may be naturally formed on only one side of the mover guideway 64.

The stopping means 45 is elastically operated while having interference with the uneven interference face, thus controlling the movement of the mover 40. If the interference faces 62 are formed on opposite sides of the mover 40, the stopping means 45 are naturally formed on both sides of the mover 40 to correspond to the interference faces 62. The stopping means 45 may be formed in a projection or a plate spring as shown in the accompanying drawings of the present invention. Any structure may be applied to the stopping means 45 as long as it interferes with the interference face 62.

The shielding panel 50 is coupled to the housing 20 via the coupler 30, may have a polygonal shape such as a circular or rectangular shape, and an area of the shielding panel 50 only has to shield sunlight. Preferably, a mirror 80 is attached to a surface of the shielding panel 50 facing the driver. Thus, in the case of seeing a driver's face or putting on makeup while stopping or parking the vehicle, a separate mirror is not required, thus enabling convenient use, and the position of the shielding panel 50 can be easily changed, thus allowing the shielding panel 50 to be moved instead of moving the driver's face.

In this context, if the shielding panel 50 is not freely movable but is fixed to the coupler 30, the position of the shielding panel 50 may be changed within a predetermined range and is not effectively used because the shielding panel 50 itself is fixed.

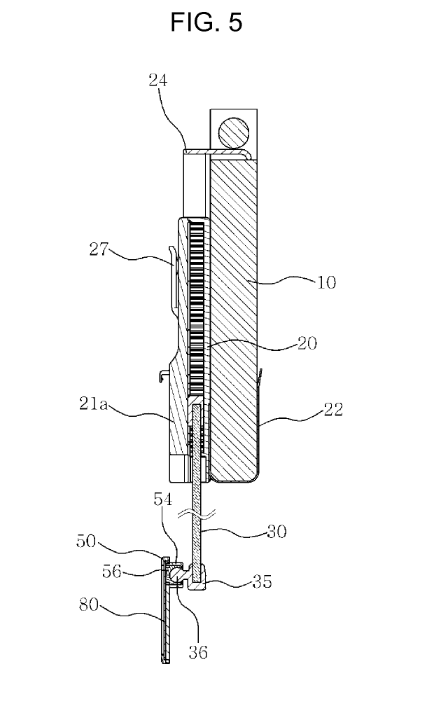

In order to solve the problem, the shielding panel 50 is installed to be freely movable relative to the coupler 30. A configuration wherein the shielding panel 50 is installed to be freely movable relative to the coupler 30 is as shown in FIG. 5. That is, a fitting member 35 having a circular fitting protrusion 36 is provided on the other end of the coupler 30, a connector portion 54 is formed on one side of the shielding panel 50 so that a coupler connecting connector is inserted therein, and the fitting protrusion 36 is fitted into an insertion hole formed in the coupler connecting connector 56. Consequently, the shielding panel 50 is installed to be freely movable relative to the coupler 30. Therefore, since the adjustment of the angle of the shielding panel 50 as well as the movement of the shielding panel 50 is allowed, it is possible to use the shielding panel 50 as desired.

Preferably, the coupler connecting connector 56 comprises a pair of separate connectors for the easy fitting of the fitting protrusion 36. The pair of connectors is coupled with each other to define the insertion hole, thus allowing the fitting protrusion 36 to be coupled thereto. A locking step is formed on the connector portion 54 so as to prevent the coupler connecting connector 56 from being easily removed after the coupler connecting connector 56 has been inserted.

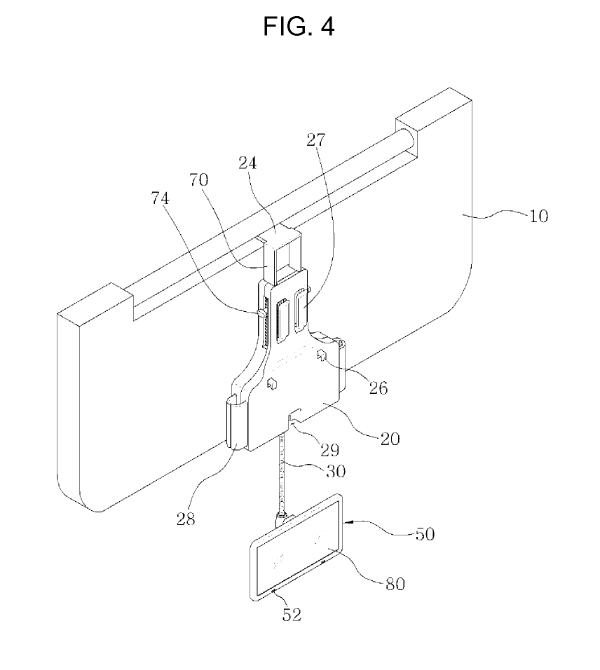

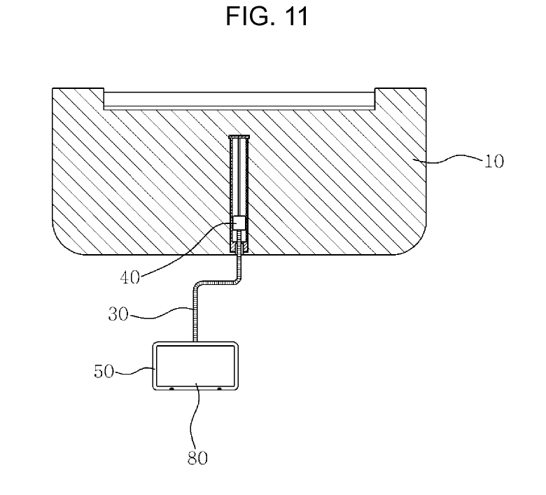

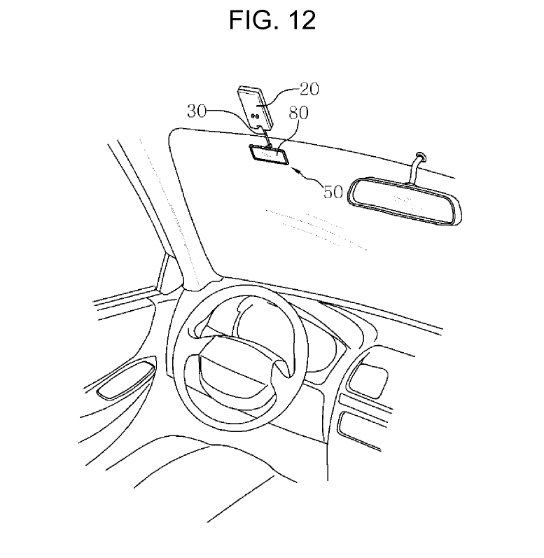

Such a sun visor for shielding sunlight may be mounted to the upper surface in the vehicle or a sun-visor plate 10 of the vehicle. In the case where the sun visor is mounted to the upper surface in the vehicle as shown in FIG. 12, the sun visor may be riveted using a hole separately formed in the housing 20 or be adhered using an adhesion member. Meanwhile, in the case where the sun visor is mounted to the sun-visor plate 10 of the vehicle, the housing 20 may be detachably mounted to the sun-visor plate 10 as shown in FIGS. 4 and 5, or may be installed in the sun-visor plate 10 during the manufacture of the sun-visor plate 10 as shown in FIGS. 10 and 11.

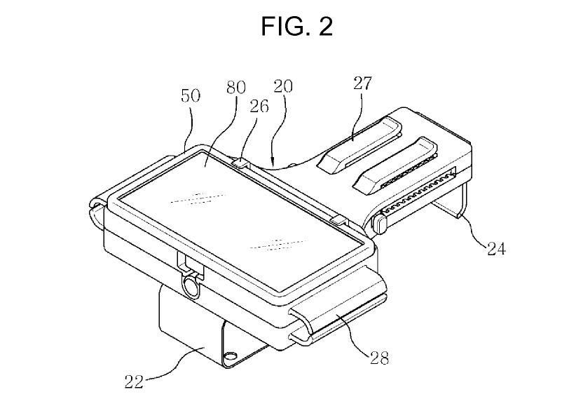

As shown in FIGS. 2 to 5, in the case of detachably mounting the sun visor to the sun-visor plate 10 of the vehicle, a clamp 22 is provided on one side of the housing 20. Thus, the sun visor can be detachably fitted to any side of the sun-visor plate 10 of the vehicle using the clamp 22.

The clamp 22 may be installed at any position of the housing 20. However, the clamp 22 is preferably provided on a portion of the housing 20 having a wide area so as to prevent the housing 20 from shaking when being coupled to the sun-visor plate 10 (see FIG. 3).

Due to the fitting of the clamp 22, the housing 20 can be stably coupled to the sun-visor plate 10 in such a way as to not move. However, in order to prevent the housing 20 from being separated from the sun-visor plate 10 caused by several reasons including the shaking during the driving of the vehicle, a catcher 24 is provided on the housing 20 to be caught by the other side of the sun-visor plate 10.

The catcher 24 is formed such that an end thereof is shaped like a hook, and is preferably formed on the other side of the housing 20 facing the clamp 22. The catcher 24 is mounted to the other side of the sun-visor plate 10 which is opposite to one side of the sun-visor plate 10 to which the clamp 22 is fitted. As the position of the catcher 24 is moved by a position moving means, the catcher 24 is moved with respect to the housing 20.

Thus, the catcher 24 can be properly adjusted and then coupled to correspond to the sun-visor plate having a different size depending on the kind of the vehicle, thus enabling effective use.

The position moving means for adjusting the position of the catcher 24 according to an embodiment includes a pair of coupling bars 70 that are connected to one side of the catcher 24 in such a way as to be parallel to each other and are inserted into the housing 20. A locking protrusion 72 is formed on an end of an outer surface of each coupling bar 70. A press portion 74 is provided on each coupling bar 70 to engage or disengage the locking protrusion 72 with or from an uneven portion. The uneven portion 76 is provided in the housing 20 to engage with the locking protrusion 72 and thereby control the movement of the catcher 24.

The position of the catcher 24 is moved as follows. That is, if a driver presses the press portion 74, the locking protrusion 72 is removed from the uneven portion 76. In this state, the catcher 24 moves in any one direction with the press portion 74 being pressed, to take each coupling bar 70 into or out of the housing 20, thus adjusting the position of the catcher 24. Subsequently, if the press portion 74 is released from the pressed state so as to fix the position of the catcher 24, the locking protrusion 72 engages with the uneven portion 76, so that the movement of the catcher 24 is prevented.

Here, the position moving means is not limited to the above-mentioned structure, but may utilize any structure as long as it may take the catcher 24 in or out of the housing 20, such as a structure wherein the mover of the present invention moves along the mover guide.

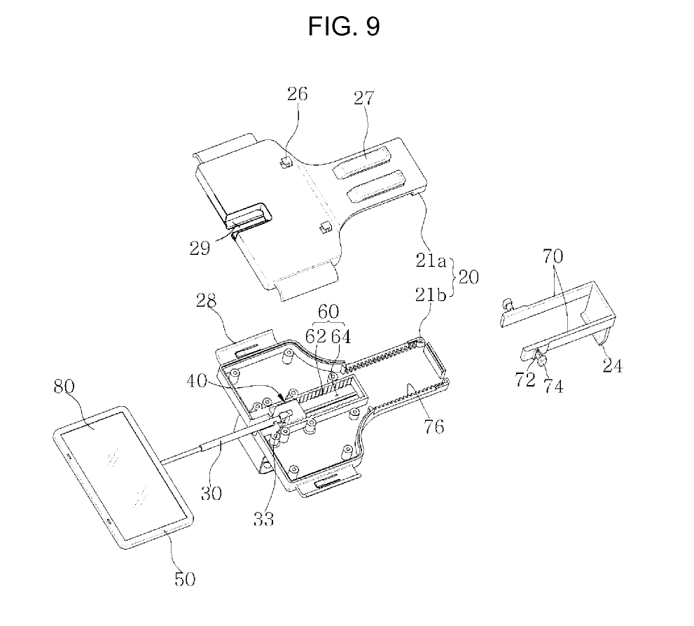

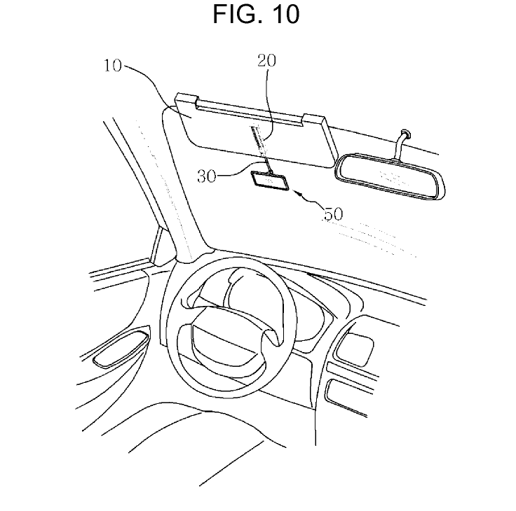

Meanwhile, the coupler 30 is preferably made of a flexible material that is freely bent and maintains a bent state so as to allow the shielding panel 50 to move to a desired position. Further, as shown in FIG. 9, the coupler 30 may be provided in the form of a telescopic antenna.

Preferably, the rotating angle of the coupler 30 is designed to be large, thus allowing the shielding panel 50 to move more smoothly. By way of example, a circular protruding portion 33 is provided on one end of the coupler 30 to move freely from the mover 40 without being removed therefrom because the protruding portion 33 is surrounded by the mover 40. Further, cut grooves 41 are formed along two surfaces of the mover 40 to increase an angular range of the coupler 30 for the movement of the protruding portion 33, thus allowing the shielding panel 50 to be moved to a desired position.

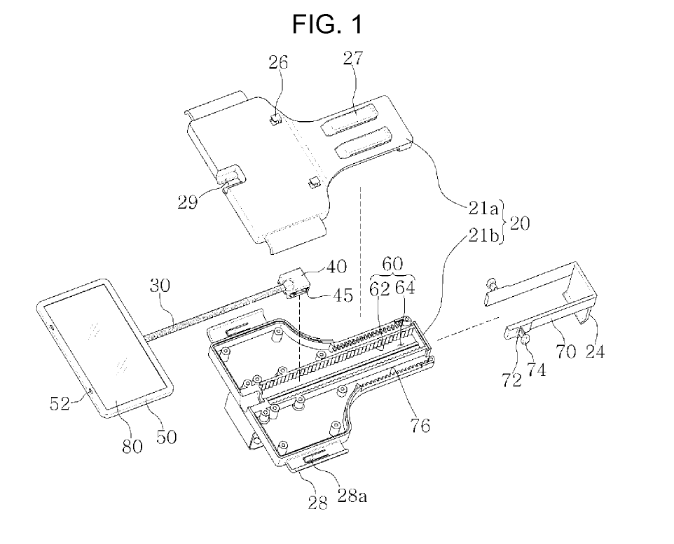

The length and structure of the mover guide 60 may be changed depending on the form of the coupler 30. For example, when the coupler 30 is flexible, the mover guide 60 is preferably formed lengthily in a longitudinal direction of the housing 20 as shown in FIG. 1. On the other hand, when the coupler 30 is in the form of the antenna, it is unnecessary to form the mover guide 60 lengthily, so that the mover guide 60 may be formed to be short as shown in FIG. 9.

The sun visor for shielding sunlight according to the present invention is configured so that the shielding panel 50 overlaps with the housing 20 to occupy a minimum area. When the coupler 30 is taken into the housing 20, a surface of the shielding panel 50 comes into contact with a surface of the housing 20 so that the shielding panel 50 overlaps with the housing 20.

When the shielding panel 50 overlaps with the housing 20, the connector portion 54 prevents the entire shielding panel 50 from overlapping with the housing 20. Thereby, a connector fitting recess 29 is a portion of the housing 20 into which the coupler 30 is taken, and is formed to correspond to the shape of the connector portion 54, so that the connector portion 54 is fitted and coupled into the connector fitting recess 29.

Further, a shielding-panel fastening hook 26 is formed at a position on a surface of the housing 20, and is fastened to a fastening slit 52 that is formed at a position of the shielding panel 50, thus maintaining the overlapping state of the shielding panel 50 with the housing 20.

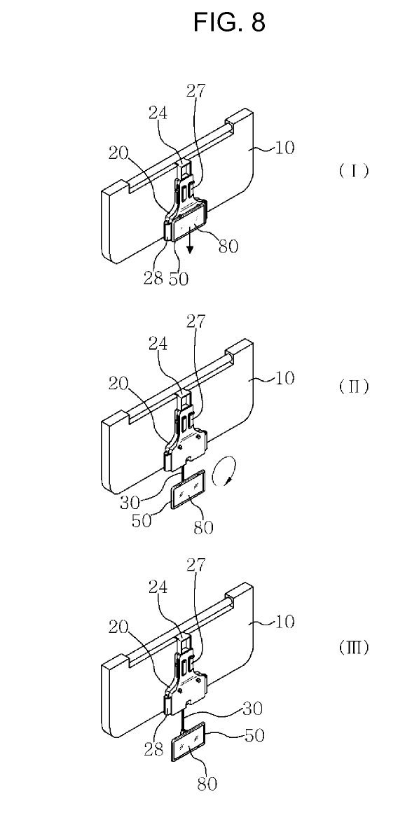

As such, when using the shielding panel 50 that is fastened to the shielding-panel fastening hook 26 to overlap with a surface of the housing 20, as shown in FIG. 8, the shielding panel 50 overlaps with the housing 20 before use (I). After the shielding panel 50 overlapping with the housing 20 is pulled to be released from the shielding-panel fastening hook 26, the shielding panel 50 is separated from the housing 20 (II). Thereafter, the shielding panel 50 is rotated at a desired angle and is also moved to a desired position to use the sun visor (III).

In the case where the sun visor for shielding sunlight according to the present invention constructed as described above is attached to the sun-visor plate 10 of the vehicle, the shielding panel 50 overlaps with the housing 20 to be in close contact therewith when the sun visor is not in use. In contrast, when the sun visor is in use, the shielding panel 50 is separated from the housing 20 as shown in FIG. 8 and then is rotated at a desired angle and moved to a desired position.

When the shielding panel 50 overlaps with the housing 20 to be in close contact therewith or is separated therefrom, the coupler 30 coupled with the shielding panel 50 is taken into the housing 20 or taken out of the housing 20. In this case, it is easy to take the coupler 30 in and out of the housing 20, thus enabling convenient use. Further, when the shielding panel 50 is not in use, it may overlap with the housing 20 to be stored, thus offering a well-ordered and good appearance. If the mirror is provided on the shielding panel 50, a driver can see his or her face merely by moving the shielding panel 50 to a desired position without the necessity of his or her head movement. Such a structure can eliminate inconvenience resulting from a driver's movement, unlike a conventional method of using a mirror installed in a vehicle.

As described above, the present invention provides a sun visor for shielding sunlight, in which a coupler is taken in and out in a sliding manner to facilitate the length adjustment of the coupler and is also in the form of an antenna to increase or reduce the length thereof, and in which a shielding panel is in close contact with a surface of a body to be stored when the shielding panel is not in use, thus providing a well-ordered and good appearance, and in which the sun visor can be correspondingly mounted to a sun-visor plate with a different area depending on a kind of a vehicle, thus ensuring a convenient use.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A sun visor for shielding sunlight, comprising:
a housing;
a coupler inserted at a first end thereof into the housing to be taken into or out of the housing, with a fitting member provided on a second end of the coupler;
a mover coupled to the first end of the coupler in such a way as to be provided in the housing, with stopping means provided on one side or both sides of the mover;
a shielding panel movably coupled to the fitting member of the coupler to adjust an angle thereof, and shielding a driver's eyes from sunlight; and
a mover guide provided in the housing, and including an interference face to control movement of the mover by interference with the stopping means, and a mover guideway to guide the movement of the mover in a space defined by the interference face.

2. The sun visor as set forth in claim 1, wherein the housing is mounted to an upper surface in the vehicle or detachably mounted to or the sun-visor plate of the vehicle, and
when the housing is detachably mounted to the sun-visor plate of the vehicle, a clamp is provided on a first side of the housing to allow the housing to be detachably coupled to a first side of the sun-visor plate of the vehicle.

3. The sun visor as set forth in claim 2, wherein a catcher is provided on a second side of the housing in such a way as to face the clamp and is caught by a second side of the sun-visor plate, the catcher being provided such that a position thereof is moved by position moving means.

4. The sun visor as set forth in claim 3, wherein the position moving means comprises:
a pair of coupling bars coupled to a first side of the catcher in such a way as to be parallel to each other, and inserted into the housing;
a locking protrusion formed on an end of an outer surface of each of the coupling bars;
a press portion formed on each of the coupling bars to cause the locking protrusion to engage with or disengage from an uneven portion; and
the uneven portion provided in the housing and engaging with the locking protrusion to control movement of the catcher.

5. The sun visor as set forth in claim 1, wherein the coupler is formed flexible to be bent freely and maintain a bent state, and
a mirror is attached to a surface of the shielding panel.

6. The sun visor as set forth in claim 5, wherein a circular protruding portion is provided on the first end of the coupler to be surrounded by the mover and thus be freely movable from the mover without being removed therefrom, the mover comprising cut grooves that are formed along two surfaces of the mover to increase an angular range of the coupler as the protruding portion moves.

7. The sun visor as set forth in claim 1, wherein the coupler is provided in a form of a telescopic antenna, and
a circular protruding portion is provided on the first end of the coupler to be surrounded by the mover and thus be freely movable from the mover without being removed therefrom, the mover comprising cut grooves that are formed along two surfaces of the mover to increase an angular range of the coupler as the protruding portion moves.

8. The sun visor as set forth in claim 1, wherein
a circular fitting protrusion is provided on the fitting member, and
a connector portion is provided on a first side of the shielding panel to allow the shielding panel to move freely, with a coupler connecting connector being inserted into the connector portion, the fitting protrusion being fitted and coupled to the coupler connecting connector.

9. The sun visor as set forth in claim 1, wherein, when the coupler is taken into the housing, a surface of the shielding panel is in contact with a surface of the housing so that the shielding panel overlaps with the housing, and
a shielding-panel fastening hook is provided on the surface of the housing to fasten the shielding panel thereto and thereby maintain an overlapping state.
